(19) United States
(12) Patent Application Publication
(10) Pub. No.: US 2026/0103421 A1
(43) Pub. Date: Apr. 16, 2026

(54) ETCHING DEVICE AND METHOD OF MANUFACTURING WINDOW

(71) Applicant: Samsung Display Co., LTD., Yongin-si (KR)

(72) Inventors: BEOMSOO KIM, Yongin-si (KR); SEUNGJUN LEE, Yongin-si (KR); JAEBOK LEE, Yongin-si (KR)

(21) Appl. No.: 19/327,365

(22) Filed: Sep. 12, 2025

(30) Foreign Application Priority Data
Oct. 10, 2024 (KR) 10-2024-0137652

(51) Int. Cl. C03C 15/00

(52) U.S. Cl. CPC C03C 15/00

(57) ABSTRACT

An etching device includes a mask part including a first mask disposed on a surface of a target substrate, a second mask disposed on the surface and spaced apart from the first mask in a first direction, and a third mask disposed on another surface of the target substrate facing the surface. The etching device includes an adhesive layer including a first adhesive layer disposed between the first mask and the target substrate, a second adhesive layer spaced apart from the first adhesive layer in the first direction and disposed between the second mask and the target substrate, and a third adhesive layer disposed between the third mask and the target substrate.

This application claims priority to Korean Patent Application No. 10-2024-0137652, filed on Oct. 10, 2024, and all the benefits accruing therefrom under 35 U.S.C. § 119, the content of which in its entirety is herein incorporated by reference.

### BACKGROUND

### 1. Field

The present disclosure relates to an etching device and a method of manufacturing a window. More particularly, the present disclosure relates to an etching device used to manufacture a foldable window and a method of manufacturing the foldable window.

### 2. Description of Related Art

A display device includes a display area that is activated in response to electrical signals. The display device senses an input provided from the outside through the display area and displays images to provide a user with information through the display area. With the recent development of display devices of various shapes, research on foldable display devices has been actively conducted, and the need for an efficient etching method for ultra-thin glass (UTG) to implement foldable characteristics has emerged.

### SUMMARY

The present disclosure provides an etching device used to manufacture a window with foldable properties and improved reliability.

The present disclosure provides a method of manufacturing the window with foldable properties and improved reliability through a simplified process.

Embodiments of the inventive concept provide an etching device including a mask part including a first mask disposed on a surface of a target substrate, a second mask disposed on the surface and spaced apart from the first mask in a first direction, and a third mask disposed another surface of the target substrate, wherein the other surface of the target substrate faces the surface and an adhesive layer including a first adhesive layer disposed between the first mask and the target substrate, a second adhesive layer spaced apart from the first adhesive layer in the first direction and disposed between the second mask and the target substrate, and a third adhesive layer disposed between the third mask and the target substrate.

The first mask includes a first lower portion disposed on the first adhesive layer, a first intermediate portion disposed on the first lower portion, and a first upper portion disposed on the first intermediate portion. The second mask includes a second lower portion disposed on the second adhesive layer, a second intermediate portion disposed on the second lower portion, and a second upper portion disposed on the second intermediate portion.

The first upper portion includes a first upper base portion aligned with an end of the first lower portion and a first upper protrusion portion extending from the first upper base portion in the first direction. The second upper portion includes a second upper base portion aligned with an end of the second lower portion and a second upper protrusion portion extending from the second upper base portion in a direction opposite to the first direction.

A first distance in the first direction between the first lower portion and the second lower portion is substantially equal to a second distance in the first direction between the first intermediate portion and the second intermediate portion.

A first distance in the first direction between the first lower portion and the second lower portion is greater than a third distance in the first direction between the first upper portion and the second upper portion.

A second distance in the first direction between the first intermediate portion and the second intermediate portion is greater than a third distance in the first direction between the first upper portion and the second upper portion.

A width in the first direction between the first adhesive layer and the second adhesive layer is greater than a third distance in the first direction between the first upper portion and the second upper portion.

The first adhesive layer includes a first adhesive base portion and a first cured portion extending from the first adhesive base portion in the first direction, the second adhesive layer includes a second adhesive base portion and a second cured portion extending from the second adhesive base portion in the direction opposite to the first direction, the first cured portion is not attached to the target substrate, and the second cured portion is not attached to the target substrate.

Each of a width in the first direction of the first cured portion and a width in the first direction of the second cured portion ranges from about 1 mm to about 10 mm.

The first mask is disposed directly on an upper surface of the first adhesive layer, the second mask is disposed directly on an upper surface of the second adhesive layer, and the third mask is disposed directly on a lower surface of the third adhesive layer.

Each of a thickness of the first lower portion and a thickness of the second lower portion ranges from about 50 micrometers to about 400 micrometers.

Each of a sum of a thickness of the first intermediate portion and a thickness of the first upper portion and a sum of a thickness of the second intermediate portion and a thickness of the second upper portion ranges from about 500 micrometers to about 2000 micrometers.

The adhesive layer has a thickness ranging from about 1 micrometer to about 100 micrometers.

A third distance in the first direction between the first upper portion and the second upper portion ranges from about 5 mm to about 25 mm.

A second distance in the first direction between the first intermediate portion and the second intermediate portion ranges from about 15 mm to about 75 mm.

A second distance in the first direction between the first intermediate portion and the second intermediate portion decreases along a thickness direction of the etching device.

Each of the first mask, the second mask, and the third mask may include at least one of Teflon, polyethylene, polyvinylchloride, or polyether ether ketone.

Each of the first upper portion and the second upper portion includes at least one of Teflon, polyvinylchloride, or polyether ether ketone.

Embodiments of the inventive concept provide a method of manufacturing a window. The method includes a first operation of preparing: a target substrate, a first set including a preliminary first adhesive layer and a first mask disposed on the preliminary first adhesive layer, a second set including a second adhesive layer and a second mask disposed on the second adhesive layer, a third set including a third adhesive layer and a third mask disposed on a lower surface of the third adhesive layer, and a chamber accommodating an etching solution, a second operation of forming a target substrate set, including: attaching the first set to a surface of the target substrate using the first adhesive layer, attaching the second set to the surface of the target substrate using the second adhesive layer such that the second set is spaced apart from the first set in a first direction, and attaching the third set to another surface of the target substrate using the third adhesive layer, wherein the other surface of the target substrate faces the surface, and a third operation of forming the window, including: moving the target substrate set in a second direction intersecting the first direction and immersing the target substrate set into the etching solution in the chamber.

The first mask includes a first lower portion disposed on the first adhesive layer, a first intermediate portion disposed on the first lower portion, and a first upper portion disposed on the first intermediate portion.

The second mask includes a second lower portion disposed on the second adhesive layer, a second intermediate portion disposed on the second lower portion, and a second upper portion disposed on the second intermediate portion.

The first upper portion includes a first upper base portion aligned with an end of the first lower portion and a first upper protrusion portion extending from the first upper base portion in the first direction.

The second upper portion includes a second upper base portion aligned with an end of the second lower portion and a second upper protrusion portion extending from the second upper base portion in a direction opposite to the first direction.

The method further includes irradiating each of the first set and the second set with an ultraviolet light, between the first operation and the second operation, wherein irradiating each of the first set and the second set with the ultraviolet light cures a portion of the first adhesive layer and a portion of the second adhesive layer.

Based on the second operation, the first adhesive layer includes a first adhesive base portion and a first cured portion extending from the first adhesive base portion in the first direction.

Based on the second operation, the second adhesive layer includes a second adhesive base portion and a second cured portion extending from the second adhesive base portion in the direction opposite to the first direction.

In the third operation, a portion of the etching solution is provided between the first cured portion and the target substrate and between the second cured portion and the target substrate.

The third operation includes moving the target substrate set in an arbitrary direction and a direction opposite the arbitrary direction at a speed ranging from about 100 mm/min to about 500 mm/min while the target substrate set is immersed in the etching solution.

According to the above, the etching device includes the adhesive layer placed on the upper surface and the lower surface of the target substrate and the mask part disposed on the adhesive layer and is able to manufacture the window with foldable characteristics and improved reliability through a simple process.

According to the method of manufacturing the window, the window with foldable characteristics and improved reliability is manufactured through a simple process using the etching device, which includes the adhesive layer placed on the upper and lower surfaces of the target substrate and the mask part disposed on the adhesive layer, and thus, the process difficulty is reduced.

### BRIEF DESCRIPTION OF THE DRAWINGS

FIGS. 1A to 1C are perspective views illustrating a display device according to an embodiment of the present disclosure;

FIG. 2 is an exploded perspective view illustrating a display device according to an embodiment of the present disclosure;

FIGS. 3A and 3B are cross-sectional views illustrating display devices taken along a line I-I′ of FIG. 2;

FIG. 4 is a perspective view illustrating an etching device and a chamber according to an embodiment of the present disclosure;

FIG. 5 is a perspective view illustrating an etching device according to an embodiment of the present disclosure;

FIGS. 6A and 6B are cross-sectional views illustrating etching devices taken along a line II-II′ of FIG. 5;

FIG. 7 is a perspective view illustrating an etching device according to an embodiment of the present disclosure;

FIGS. 8A and 8B are cross-sectional views illustrating etching devices taken along a line III-III′ of FIG. 7;

FIG. 9 is a flowchart illustrating a method of manufacturing a window according to an embodiment of the present disclosure;

FIGS. 10 to 15 are views illustrating a method of manufacturing a window according to an embodiment of the present disclosure;

FIG. 16 is a perspective view illustrating a window according to an embodiment of the present disclosure; and

FIG. 17 is a cross-sectional view illustrating a window taken along a line IV-IV′ of FIG. 16.

### DETAILED DESCRIPTION

In the present disclosure, it will be understood that when an element (or area, layer, or portion) is referred to as being “on”, “connected to” or “coupled to” another element or layer, it can be directly on, connected or coupled to the other element or layer or intervening elements or layers may be present.

Like numerals refer to like elements throughout. In the drawings, the thickness, ratio, and dimension of components are exaggerated for effective description of the technical content. As used herein, the term “and/or” may include any and all combinations of one or more of the associated listed items.

It will be understood that, although the terms first, second, and the like may be used herein to describe various elements, these elements should not be limited by these terms. These terms are used to distinguish one element from another element. Thus, a first element discussed below could be termed a second element without departing from the teachings of the present disclosure. As used herein, the singular forms, “a”, “an” and “the” are intended to include the plural forms as well, unless the context clearly indicates otherwise.

Spatially relative terms, such as “beneath”, “below”, “lower”, “above”, “upper” and the like, may be used herein for ease of description to describe one element or feature's relationship to another elements or features as illustrated in the figures.

It will be further understood that the terms “include” and/or “including”, when used in this specification, specify the presence of stated features, integers, steps, operations, elements, and/or components, but do not preclude the presence or addition of one or more other features, integers, steps, operations, elements, components, and/or groups thereof.

In the present disclosure, when an element is referred to as being “directly disposed” to another element, there are no intervening elements present between a layer, film region, or substrate and another layer, film, region, or substrate. For example, the term “directly disposed” may mean that two layers or two members are disposed without employing additional adhesive therebetween.

The terms “about” or “approximately” as used herein are inclusive of the stated value and include a suitable range of deviation for the particular value as determined by one of ordinary skill in the art, considering the measurement in question and the error associated with measurement of the particular quantity. The terms “about” or “approximately” can mean within one or more standard deviations, or within ±30%, 20%, 10%, 5% of the stated value, for example.

The term “substantially,” as used herein, means approximately or actually. The term “substantially equal” means approximately or actually equal. The term “substantially the same” means approximately or actually the same. The term “substantially perpendicular” means approximately or actually perpendicular. The term “substantially parallel” means approximately or actually parallel.

Unless otherwise defined, all terms including technical and scientific terms used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, embodiments of the present disclosure will be described with reference to accompanying drawings.

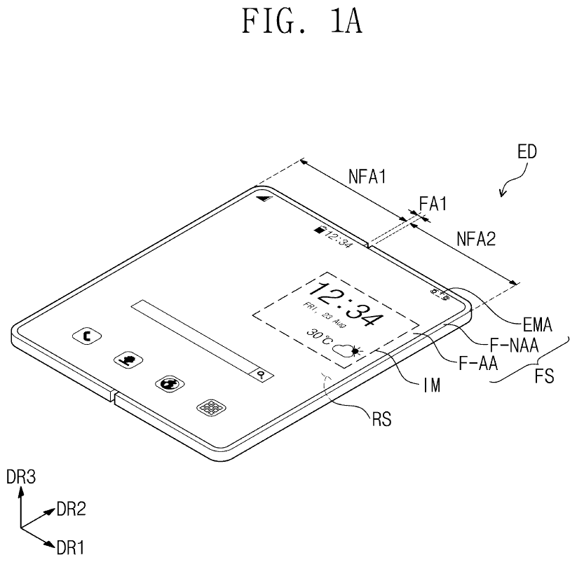

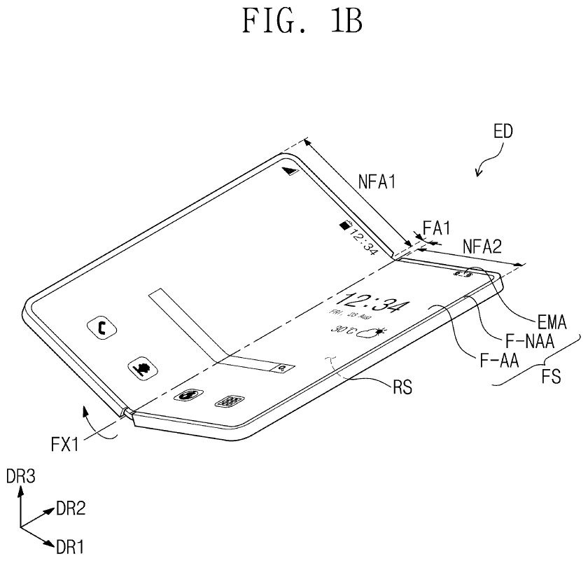

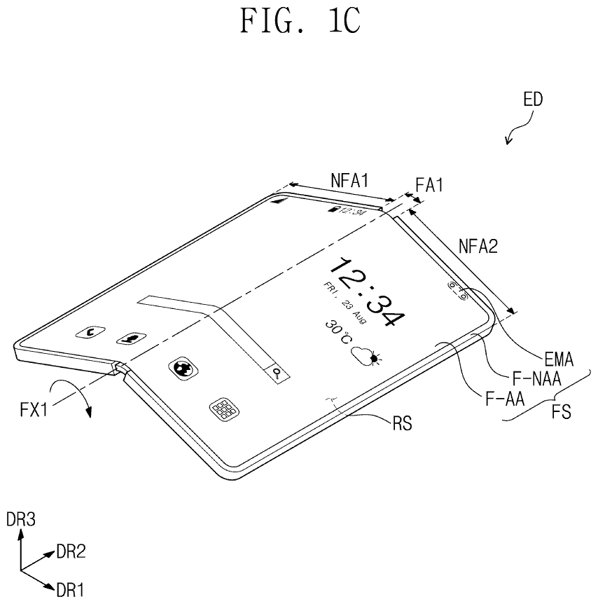

FIGS. 1A to 1C are perspective views of a display device according to an embodiment of the present disclosure. FIG. 1A illustrates an unfolded state of the display device, and FIGS. 1B and 1C illustrate a folded state of the display device.

FIGS. 1A to 1C illustrate a foldable display device as the display device ED, however, the present disclosure should not be limited thereto or thereby. The display device ED may be a flexible display device that is bendable or rollable.

The display device ED may include a display surface FS defined by a first direction DR1 and a second direction DR2 intersecting the first direction DR1. The display device ED may provide an image IM to a user through the display surface FS. The display device ED may display the image IM through the display surface FS, which is substantially parallel to each of the first direction DR1 and the second direction DR2, toward a third direction DR3.

The display surface FS of the display device ED may include an active area F-AA and a peripheral area F-NAA. The active area F-AA of the display device ED may be activated in response to electrical signals. The display device ED may display the image IM through the active area F-AA. In some aspects, various external inputs may be sensed through the active area F-AA. The peripheral area F-NAA may be defined adjacent to the active area F-AA. The peripheral area F-NAA may have a color. The peripheral area F-NAA may surround the active area F-AA. Accordingly, the active area F-AA may have a shape that is substantially defined by the peripheral area F-NAA, however, this is an example. The peripheral area F-NAA may be defined adjacent to a single side of the active area F-AA or may be omitted. According to an embodiment, the display device ED may include the active area of various shapes, but embodiments of the present disclosure are not limited thereto.

The active area F-AA may include a sensing area EMA. Various electronic modules may be disposed in the sensing area EMA. As an example, the electronic module may include one or more of a camera module, a speaker, an optical sensor, and a thermal sensor. An external object may be sensed through the sensing area EMA of the display surface FS, or a sound signal, such as, for example, a voice input, may be provided to the outside through the sensing area EMA of the display surface FS. The electronic module may include a plurality of components, but embodiments of the present disclosure are not limited thereto.

The sensing area EMA may be surrounded by the active area F-AA and the peripheral area F-NAA, but embodiments of the present disclosure are not limited thereto. The sensing area EMA may be defined in the active area F-AA, but embodiments of the present disclosure are not limited thereto. FIG. 1A illustrates one sensing area EMA as a representative example, however, the number of the sensing areas EMA should not be limited to one.

The sensing area EMA may be a portion of the active area F-AA. Accordingly, the display device ED may also display an image through the sensing area EMA. In an example in which the electronic modules disposed in the sensing area EMA are deactivated, the sensing area EMA may serve as the display surface to display the image IM (refer to FIG. 1A).

The display device ED may include a rear surface RS facing the display surface FS. The rear surface RS may be an external surface of the display device ED, and the image IM (refer to FIG. 1A) may not be displayed through the rear surface RS, however, embodiments of the present disclosure are not limited thereto. According to an embodiment, the rear surface RS may serve as a second display surface through which the image IM (refer to FIG. 1A) is displayed. In some aspects, although not illustrated in figures, the display device ED may further include a sensing area defined in the rear surface RS. A camera, a speaker, and an optical sensor may be disposed in the sensing area defined in the rear surface RS.

The display device ED may include a folding area FA and non-folding areas NFA1 and NFA2. The display device ED may include a plurality of non-folding areas NFA1 and NFA2. According to the present embodiment, the display device ED may include first and second non-folding areas NFA1 and NFA2, and the folding area FA may be disposed between the first and second non-folding areas NFA1 and NFA2. FIGS. 1A to 1C illustrate the display device ED including one folding area FA, however, the present disclosure should not be limited thereto or thereby. According to an embodiment, a plurality of folding areas may be defined in the display device ED. According to an embodiment, the display device ED may be folded with respect to a plurality of folding axes such that portions of the display surface FS to face each other, and the number of the folding axes and the number of the non-folding areas should not be particularly limited.

Referring to FIGS. 1B and 1C, the display device ED may be folded with respect to a folding axis FX1 extending in one direction. The folding axis FX1 illustrated in FIGS. 1B and 1C may be an imaginary axis extending in the second direction DR2 to be substantially parallel in a direction in which a long side of the display device ED extends. However, the direction in which the folding axis FX1 extends should not be limited to the second direction DR2.

The folding axis FX1 may extend in the second direction DR2 on the display surface FS or may extend in the second direction DR2 under the rear surface RS. Referring to FIG. 1B, the display device ED may be inwardly folded (in-folding) such that the first non-folding area NFA1 and the second non-folding area NFA2 to face each other, and thus, the display surface FS may not be exposed to the outside. In some aspects, referring to FIG. 1C, the display device ED may be outwardly folded (out-folding) about the folding axis FX1 such that a portion of the rear surface RS, which overlaps the first non-folding area NFA1, faces the other portion of the rear surface RS, which overlaps the second non-folding area NFA2.

The display device ED may be configured to repeat the unfolding operation and the in-folding operation or to repeat the unfolding operation and the out-folding operation, however, the present disclosure should not be limited thereto or thereby. According to an embodiment, the display device ED may be selectively operated in any one of the unfolding operation, the in-folding operation, and the out-folding operation.

FIGS. 1A to 1C illustrate the display device ED folded about the folding axis FX1 substantially parallel to the long side of the display device ED, however, the present disclosure should not be limited thereto or thereby. According to an embodiment, the display device may be folded about a folding axis substantially parallel to a short side of the display device.

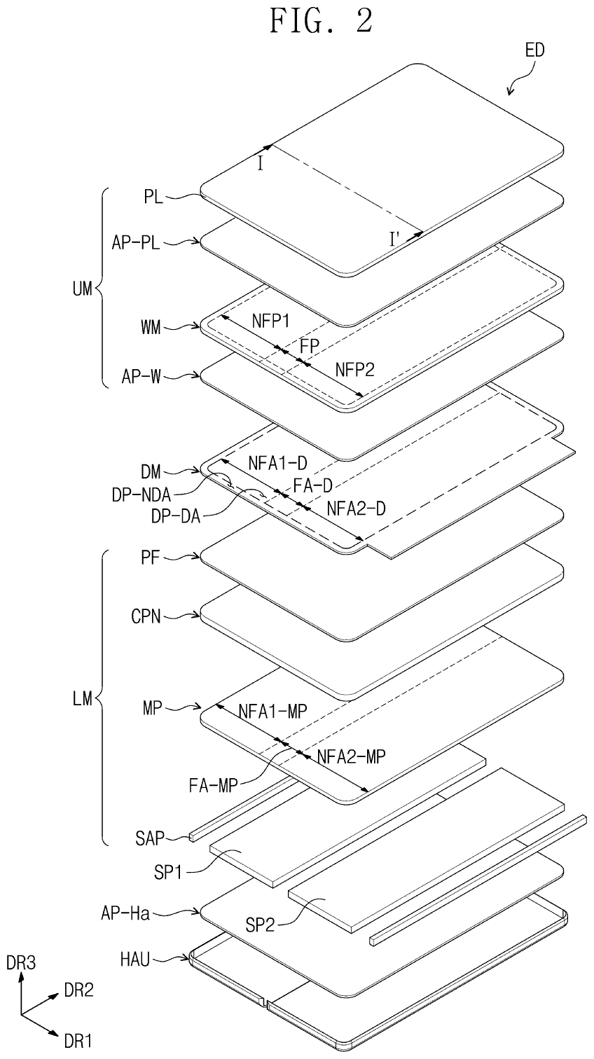

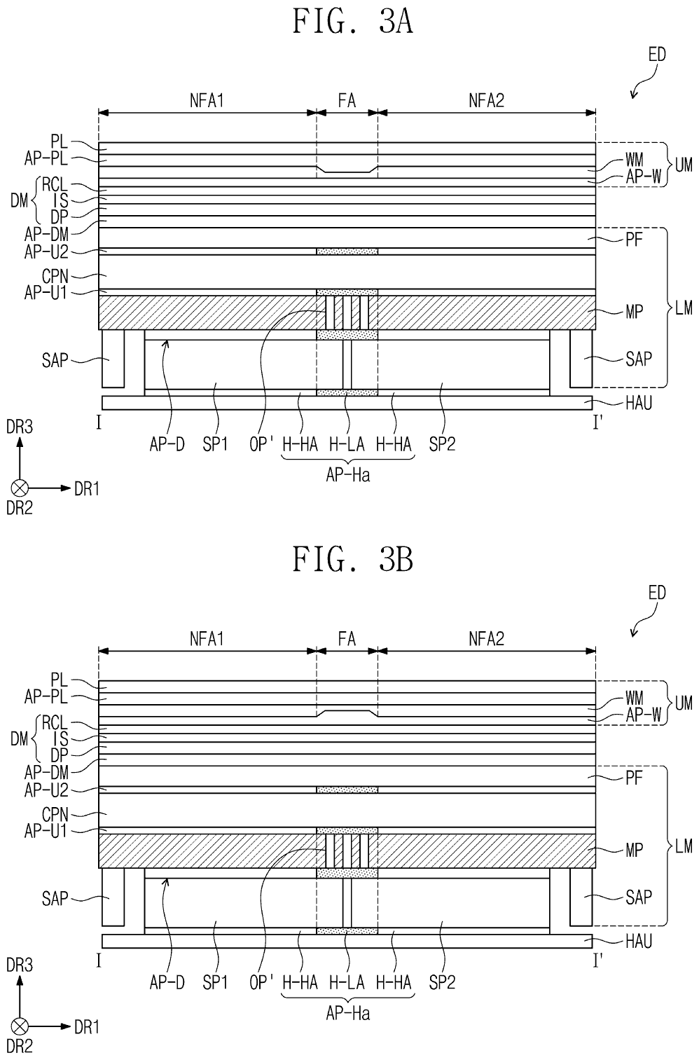

FIG. 2 is an exploded perspective view illustrating the display device according to an embodiment of the present disclosure, and FIGS. 3A and 3B are cross-sectional views illustrating display devices according to embodiments of the present disclosure. FIG. 2 is an exploded perspective view of the display device according to the embodiment illustrated in FIG. 1A. FIGS. 3A and 3B are cross-sectional views taken along a line I-I′ of FIG. 2. Different from the display device illustrated in FIG. 3A, a concave pattern is formed in a lower surface of a window of the display device illustrated in FIG. 3B.

Referring to FIGS. 2, 3A, and 3B, the display device ED may include a display module DM, an upper module UM disposed above the display module DM, and a lower module LM disposed under the display module DM. In the following descriptions, the upper module UM may be referred to as a protective member, and the lower module LM may be referred to as a support member.

The upper module UM disposed above the display module DM may function as a protective part to protect the display module DM from external impacts or may function as an optical part to prevent reflection of external light or to increase light extraction efficiency.

The upper module UM may include a window WM disposed above the display module DM, a protective layer PL disposed above the window WM, and a protective layer adhesive layer AP-PL disposed between the window WM and the protective layer PL.

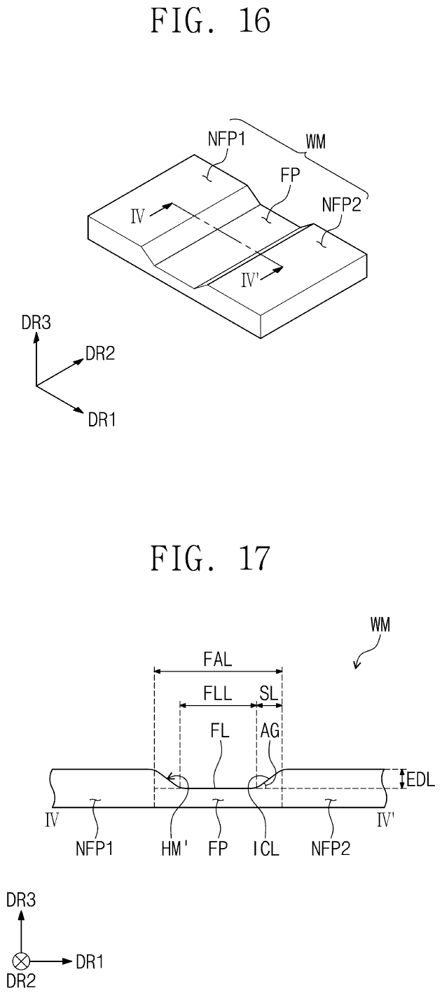

The window WM may cover the entire upper surface of the display module DM. The window WM may have a shape corresponding to a shape of the display module DM. The window WM of the display device ED may include an optically transparent insulating material. The window WM may include a glass substrate or a polymer substrate. As an example, the window WM may be a tempered glass substrate. The window WM according to the present disclosure may have a step difference formed between a folding portion FP, which corresponds to the folding area FA, and non-folding portions NFP1 and NFP2, which correspond to the non-folding areas NFA1 and NFA2, contributing to the folding characteristics of the display device ED. The step difference between the folding portion FP and the non-folding portions NFP1 and NFP2 of the window WM may be formed by a concave pattern formed in an upper surface of the window WM as illustrated in FIG. 3A or by a concave pattern formed in the lower surface of the window WM as illustrated in FIG. 3B. In the window WM according to the present disclosure, a boundary between the folding portion FP and the non-folding portions NFP1 and NFP2 may be formed gently, and thus, a distortion occurring between a display area DP-DA and a non-display area DP-NDA of the display device ED may be improved. The shape of the window WM will be described in detail with reference to FIGS. 16 and 17.

The upper module UM may further include a window adhesive layer AP-W disposed under the window WM. The window adhesive layer AP-W may be disposed between the display module DM and the window WM. The window adhesive layer AP-W may be an optically clear adhesive (OCA) film or an optically clear adhesive resin (OCR) layer. According to an embodiment, the window adhesive layer AP-W may be omitted.

The protective layer PL may be disposed above the window WM and may protect the window WM from external environments. The protective layer PL may be transparent, and thus, image (refer to IM of FIG. 1A) information provided from the display module DM may be viewed even though the protective layer PL is disposed. The protective layer PL may be an uppermost surface of the display device ED that is exposed, and the protective layer PL may be damaged depending on the usage of the display device ED.

The protective layer PL may have optical characteristics with a transmittance of about 90% or more in a visible light region and a haze value of less than about 1%. The protective layer PL may include a polymer film. In some aspects, the protective layer PL may have a polymer film as a base layer and may further include a functional layer, such as, for example, a hard coating layer, an anti-fingerprint coating layer, an antistatic coating layer, or the like, on the base layer. The protective layer PL used in the display device ED may have flexibility.

The protective layer PL may be a polymer film including at least one polymer resin among polyethylene terephthalate (PET), polybutylene terephthalate (PBT), polyethylene naphthalene (PEN), polycarbonate (PC), polymethylmethacrylate (PMMA), polystyrene (PS), polyvinylchloride (PVC), polyethersulfone (PES), polypropylene (PP), polyamide (PA), polyphenylene ether (PPO), polyoxymethylene (POM), polysulfone (PSU), polyphenylene sulfide (PPS), polyimide (PI), polyethyleneimine (PEI), polyether ether ketone (PEEK), polyamide imide (PAI), polyarylate (PAR), and thermoplastic polyurethane (TPU).

As an example, the protective layer PL may be a polyethylene terephthalate (PET) film or a thermoplastic polyurethane (TPU) film. In some aspects, the protective layer PL may be a PET film without a phase delay.

According to the display device ED, the protective layer adhesive layer AP-PL may be disposed between the window WM and the protective layer PL. The protective layer adhesive layer AP-PL may be an optically clear adhesive layer. The protective layer adhesive layer AP-PL may be attached to the window WM to fix the protective layer PL to the window WM.

The display device ED in an embodiment may include a housing HAU that accommodates the display module DM and the lower module LM. The housing HAU may be coupled to the window WM. In some aspects, the housing HAU may include a hinge structure for easy folding or bending. The hinge structure may be disposed to correspond to the folding area FA.

The display device ED in an embodiment may include a housing adhesive layer AP-Ha. The housing adhesive layer AP-Ha may function to fix the lower module LM to the housing HAU. The housing adhesive layer AP-Ha may include a folding adhesive portion H-LA corresponding to the folding area FA and non-folding adhesive portions H-HA corresponding to the non-folding areas NFA1 and NFA2. The housing adhesive layer AP-Ha may be an adhesive member to allow the lower module LM to be coupled to the housing HAU and may also function as an electromagnetic shielding layer or a heat dissipation layer.

The display module DM included in the display device ED may generate an image and may sense an input applied from the outside. The display module DM may include a display panel DP and an input sensor IS disposed on the display panel DP. In some aspects, the display module DM may further include an optical layer RCL disposed on the input sensor IS.

The display panel DP may have a configuration that substantially generates the image. The display panel DP may be a light emitting type display panel. For example, the display panel DP may be an organic light emitting display panel, an inorganic light emitting display panel, a quantum dot display panel, a micro-LED display panel, or a nano-LED display panel. The display panel DP may be referred to as a display layer.

The input sensor IS may be disposed on the display panel DP. The input sensor IS may sense an external input applied from the outside. The external input may be a user input. The user input may include various forms of external inputs, such as, for example, a part of a user's body, light, heat, pen, or pressure.

The input sensor IS may be formed on the display panel DP through successive processes. In this case, the input sensor IS may be described as being disposed directly on the display panel DP. The expression that the input sensor IS is disposed directly on the display panel DP may mean that no third component is placed between the input sensor IS and the display panel DP. That is, a separate adhesive member may not be disposed between the input sensor IS and the display panel DP. According to an embodiment, the input sensor IS may be coupled to the display panel DP by an adhesive member. The adhesive member may be a conventional adhesive.

The optical layer RCL may be disposed on the input sensor IS. The optical layer RCL may be an anti-reflective layer to reduce a reflectance of the display module DM with respect to the external light incident into the display module DM. The optical layer RCL may be formed on the input sensor IS through successive processes. The optical layer RCL may include a polarizer or a color filter layer. According to an embodiment, the optical layer RCL may include pigments or dyes and may absorb a light in a specific wavelength range. In an example in which the optical layer RCL includes the color filter layer, the color filter layer may include a plurality of color filters arranged in a selected arrangement. As an example, the color filters may be arranged by taking into account colors of lights emitted from pixels included in the display panel DP. In some aspects, the optical layer RCL may further include a partition pattern to distinguish the pixels of the display panel DP from each other. The partition pattern may include a black pigment or dye. According to an embodiment, the optical layer RCL may be omitted.

The display module DM may include the display area DP-DA and the non-display area DP-NDA. The display area DP-DA may be defined as an area in which the image provided from the display module DM is displayed.

The non-display area DP-NDA may be defined adjacent to the display area DP-DA. As an example, the non-display area DP-NDA may surround the display area DP-DA, however, this is an example. According to an embodiment, the non-display area DP-NDA may have various shapes and should not be particularly limited. The display area DP-DA of the display module DM may correspond to at least a portion of the active area F-AA (refer to FIG. 1A).

According to the display device ED, the display module DM may include a folding display portion FA-D and non-folding display portions NFA1-D and NFA2-D. The folding display portion FA-D may correspond to the folding area FA (refer to FIG. 1A), and the non-folding display portions NFA1-D and NFA2-D may correspond to the non-folding areas NFA1 and NFA2 (refer to FIG. 1A).

The folding display portion FA-D may be folded or bent about the folding axis FX1 (refer to FIG. 1B). The display module DM may include a first non-folding display portion NFA1-D and a second non-folding display portion NFA2-D, and the folding display portion FA-D may be disposed between the first non-folding display portion NFA1-D and the second non-folding display portion NFA2-D that are spaced apart from each other.

The display device ED may further include a module adhesive layer AP-DM disposed between the display module DM and the lower module LM. The module adhesive layer AP-DM may be an optically clear adhesive (OCA) film or an optically clear adhesive resin (OCR) layer.

According to the display device ED, the lower module LM may include a support plate MP and adhesive layers AP-U1, AP-U2, and AP-D disposed on and under the support plate MP. In some aspects, the lower module LM may further include one or more of support portions SP1 and SP2, a filling portion SAP, a module protective layer PF, and a buffer layer CPN. As an example, the display device ED may include the support plate MP disposed under the display module DM, the module protective layer PF and the buffer layer CPN disposed between the support plate MP and the display module DM, and the support portions SP1 and SP2 and the filling portion SAP disposed under the support plate MP.

The support plate MP may be disposed under the display module DM. The support plate MP may include a folding support portion FA-MP and non-folding support portions NFA1-MP and NFA2-MP. In the following descriptions, the folding support portion FA-MP may be referred to as a folding portion, and the non-folding support portions NFA1-MP and NFA2-MP may be referred to as non-folding portions. A first non-folding portion NFA1-MP and a second non-folding portion NFA2-MP of the support plate MP may be spaced apart from each other, and the folding portion FA-MP may be disposed between the first non-folding portion NFA1-MP and the second non-folding portion NFA2-MP. The folding portion FA-MP may correspond to the folding area FA, and the non-folding portions NFA1-MP and NFA2-MP may correspond to the non-folding areas NFA1 and NFA2.

The support plate MP may include a metal material or polymer material. As an example, the support plate MP may include stainless steel, aluminum, or an alloy thereof. In some aspects, according to an embodiment, the support plate MP may include a carbon fiber reinforced plastic (CFRP), however, the present disclosure should not be limited thereto or thereby. According to an embodiment, the support plate MP may include at least one of a non-metallic material, a plastic material, a glass fiber reinforced plastic, or a glass material.

A plurality of openings OP′ may be defined through the support plate MP. The openings OP′ may be defined to correspond to the folding area FA.

The module protective layer PF may be disposed between the display module DM and the support plate MP. The module protective layer PF may be disposed under the display module DM and may protect a rear surface of the display module DM. The module protective layer PF may entirely overlap the display module DM. The module protective layer PF may include a polymer material. As an example, the module protective layer PF may be a polyimide film or a polyethylene terephthalate film, however, materials for the module protective layer PF should not be limited thereto or thereby.

The display device ED may include the support portions SP1 and SP2 and the filling portion SAP. The support portions SP1 and SP2 may overlap most of the display module DM. The filling portion SAP may be disposed outside the support portions SP1 and SP2 and may overlap an outer portion of the display module DM.

The support portions SP1 and SP2 may include a first sub-support portion SP1 and a second sub-support portion SP2 spaced apart from the first sub-support portion SP1 in the first direction DR1. The first sub-support portion SP1 and the second sub-support portion SP2 may be spaced apart from each other in an area corresponding to the folding axis FX1 (refer to FIG. 1B). As the support portions SP1 and SP2 are provided as the first sub-support portion SP1 and the second sub-support portion SP2 that are spaced apart from each other in the folding area FA, the folding or bending characteristics of the display device ED may be improved. Although not illustrated in figures, the lower module LM may further include a cushion layer (not illustrated) disposed on or under the support portions SP1 and SP2. The cushion layer (not illustrated) may include sub-cushion layers separated from each other in an area corresponding to the folding axis FX1 (refer to FIG. 1B). A lower adhesive layer with an adhesive force smaller in an area corresponding to the folding area FA than in an area corresponding to the non-folding areas NFA1 and NFA2 may be further disposed between the support portions SP1 and SP2 and the cushion layer (not illustrated).

The cushion layer (not illustrated) may prevent the support plate MP from being pressed and deformed by external impact and force. The cushion layer (not illustrated) may include a sponge, a foam, or an elastomer such as, for example, a urethane resin. In some aspects, the cushion layer (not illustrated) may include one or more of an acrylic-based polymer, a urethane-based polymer, a silicon-based polymer, and an imide-based polymer, however, embodiments of the present disclosure are not limited thereto. According to an embodiment, the cushion layer (not illustrated) may be disposed under the support plate MP or under a lower support plate (not illustrated).

The filling portion SAP may be disposed outside the support portions SP1 and SP2. The filling portion SAP may be disposed between the support plate MP and the housing HAU. The filling portion SAP may be filled in a space between the support plate MP and the housing HAU and may fix the support plate MP.

The display device ED may include the buffer layer CPN included in the lower module LM. The buffer layer CPN may serve as a thickness compensation layer to compensate for the difference in thickness of the components disposed under the display module DM or a support layer which supports the display module DM. Unlike illustrated, in an embodiment, the buffer layer CPN may be omitted.

A combination of components included in the lower module LM in the display device ED should not be limited to those illustrated or described with reference to FIGS. 2, 3A, and 3B and may vary depending on the size, shape, and operating characteristics of the display device ED. As an example, the lower module LM may further include an additional support plate, a cushion member, an adhesive layer, and the like.

The lower module LM of the display device ED may include one or more upper adhesive layers AP-U1 and AP-U2 disposed above the support plate MP and at least one lower adhesive layer AP-D disposed under the support plate MP.

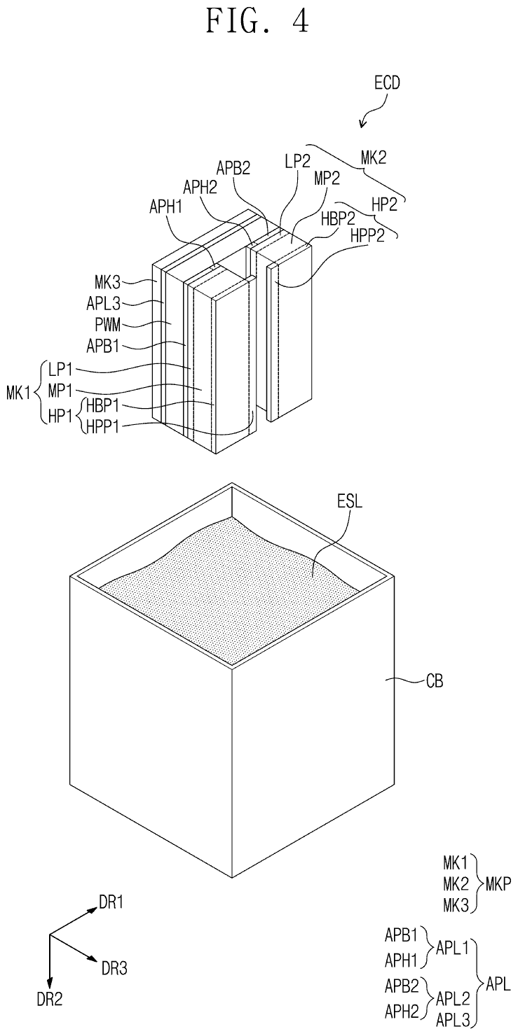

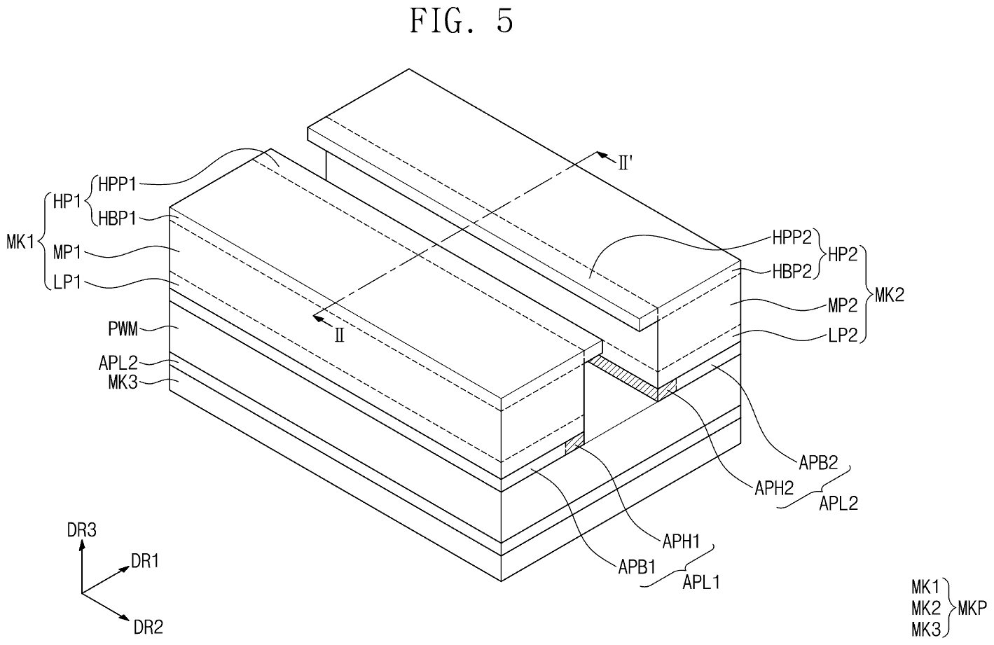

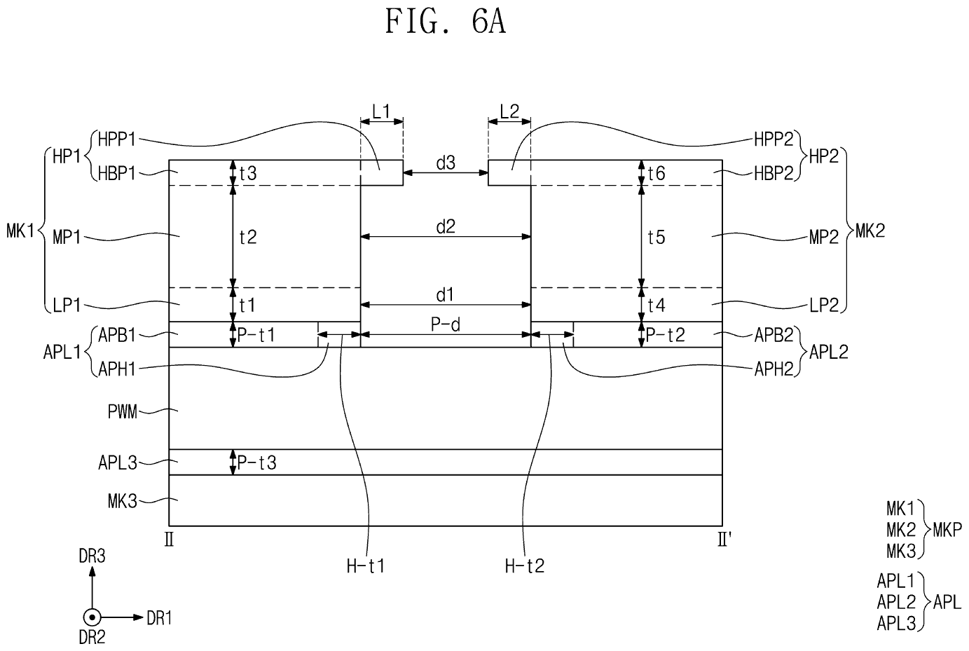

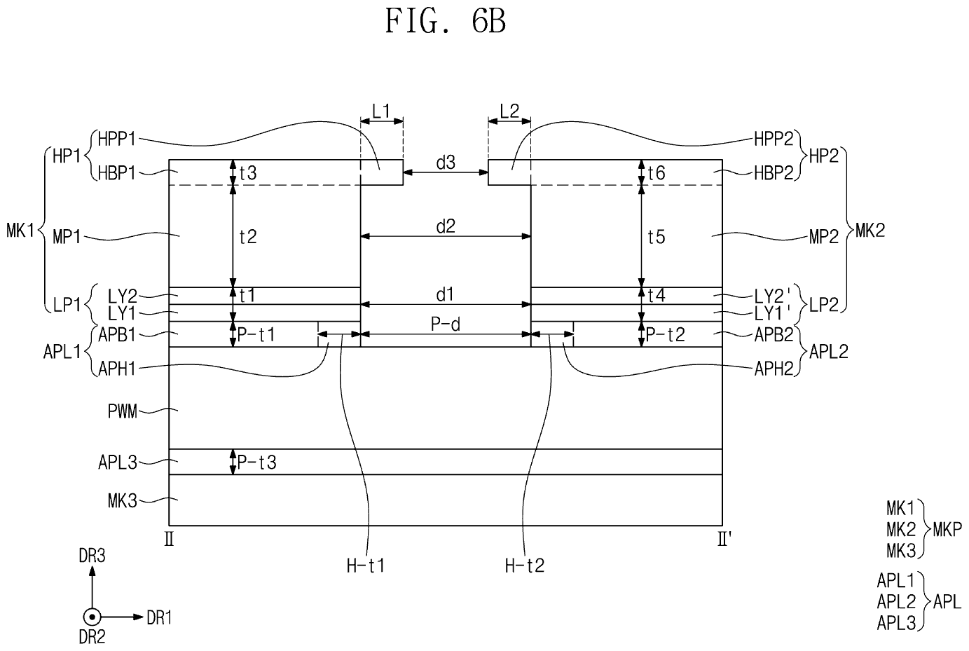

FIG. 4 is a perspective view illustrating an etching device and a chamber according to an embodiment of the present disclosure. FIG. 5 is a perspective view illustrating the etching device according to an embodiment of the present disclosure. FIGS. 6A and 6B are cross-sectional views illustrating etching devices taken along a line II-II′ of FIG. 5.

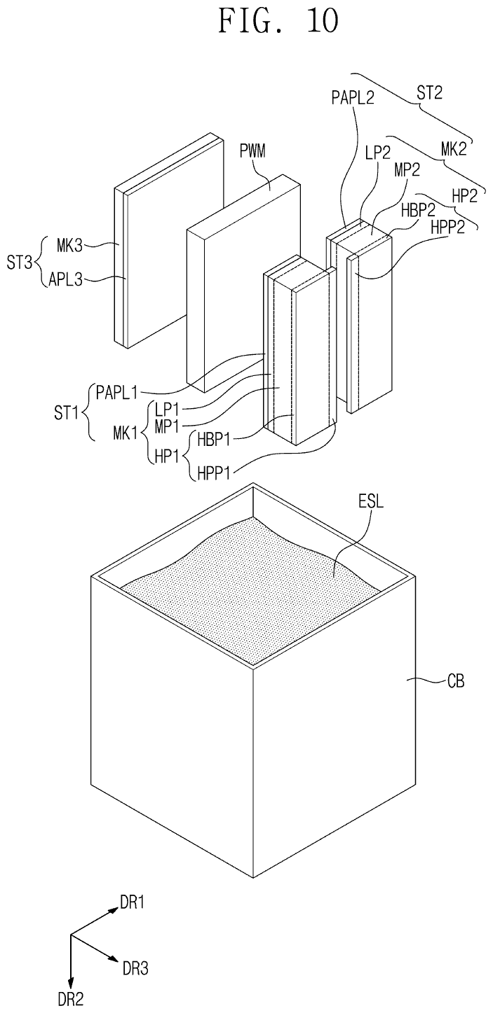

Referring to FIGS. 4, 5, and 6A, the etching device ECD may include a mask part MKP and an adhesive layer APL. The mask part MKP may be immersed into an etching solution ESL in the chamber CB while being attached to a target substrate PWM by an adhesive layer APL, and this will be described later with reference to FIGS. 10 to 17.

The mask part MKP may include a polymer compound. The mask part MKP may have a single-layer or multi-layer structure. As an example, the mask part MKP may include two layers containing different materials. The mask part MKP may include at least one of Teflon, polyethylene, polyvinylchloride, or polyether ether ketone. As an example, the mask part MKP may include polyvinylchloride. The mask part MKP may include a first mask MK1, a second mask MK2, and a third mask MK3.

The first mask MK1 may be disposed on a surface of the target substrate PWM. The first mask MK1 may be disposed directly on an upper surface of a first adhesive layer APL1 described later. An end of the first mask MK1 may be aligned with an end of the target substrate PWM. The first mask MK1 may include a first lower portion LP1, a first intermediate portion MP1, and a first upper portion HP1.

The first lower portion LP1 may be disposed on the first adhesive layer APL1 described later. The first lower portion LP1 may be disposed directly on the first adhesive layer APL1 described later. The first lower portion LP1 may include at least one of polyethylene or polyvinylchloride. As an example, the first lower portion LP1 may include polyvinylchloride. The first lower portion LP1 may have a thickness t1 ranging from about 50 micrometers to about 400 micrometers. As an example, the thickness t1 of the first lower portion LP1 may be about 100 micrometers.

The first intermediate portion MP1 may be disposed on the first lower portion LP1. The first intermediate portion MP1 may be disposed directly on the first lower portion LP1. The first intermediate portion MP1 may include at least one of Teflon, polyethylene, polyvinylchloride, or polyether ether ketone. As an example, the first intermediate portion MP1 may include polyether ether ketone. The first intermediate portion MP1 may be provided integrally with the first lower portion LP1. According to an embodiment, when the first intermediate portion MP1 is provided integrally with the first lower portion LP1, the first lower portion LP1 and the first intermediate portion MP1 may include the same material. The first intermediate portion MP1 may have hardness greater than a hardness of the first lower portion LP1.

The first upper portion HP1 may be disposed on the first intermediate portion MP1. The first upper portion HP1 may be disposed directly on the first intermediate portion MP1. The first lower portion LP1, the first intermediate portion MP1, and the first upper portion HP1 may be provided integrally with each other. The first upper portion HP1 may include at least one of Teflon, polyethylene, polyvinylchloride, or polyether ether ketone. The first lower portion LP1 and the first upper portion HP1 may include the same material. As an example, each of the first lower portion LP1, the first intermediate portion MP1, and the first upper portion HP1 may include polyethylene. The first upper portion HP1 may have hardness greater than a hardness of the first lower portion LP1. The hardness of the first upper portion HP1 may be substantially the same as the hardness of the first intermediate portion MP1. A sum of a thickness t2 of the first intermediate portion MP1 and a thickness t3 of the first upper portion HP1 may range from about 500 micrometers to about 2000 micrometers. As an example, the sum of a thickness t2 of the first intermediate portion MP1 and the thickness t3 of the first upper portion HP1 may be about 1000 micrometers.

The first upper portion HP1 may include a first upper base portion HBP1 and a first upper protrusion portion HPP1. The first upper base portion HBP1 may be disposed directly on the first intermediate portion MP1. An end of the first upper base portion HBP1 may be aligned with an end of the first lower portion LP1. The end of the first upper base portion HBP1 may be aligned with an end of the first intermediate portion MP1. The first upper base portion HBP1 may have substantially the same area as an area of the first intermediate portion MP1 when viewed in the plane. The first upper protrusion portion HPP1 may extend from the first upper base portion HBP1 in the first direction DR1. The first upper protrusion portion HPP1 may have substantially the same thickness as the first upper base portion HBP1. A width L1 in the first direction DR1 of the first upper protrusion portion HPP1 may range from about 5 millimeters (mm) to about 25 mm. As an example, the width L1 in the first direction DR1 of the first upper protrusion portion HPP1 may be about 20 mm.

The second mask MK2 may be disposed on the surface of the target substrate PWM. The second mask MK2 may be spaced apart from the first mask MK1 in the first direction DR1. The second mask MK2 and the first mask MK1 may be disposed at the same layer. The second mask MK2 may overlap the first mask MK1 when viewed in the first direction DR1. The second mask MK2 may be disposed directly on an upper surface of a second adhesive layer APL2. An end of the second mask MK2 may be aligned with an end of the target substrate PWM. The second mask MK2 may include a second lower portion LP2, a second intermediate portion MP2, and a second upper portion HP2.

The second lower portion LP2 may be disposed on the second adhesive layer APL2 described later. The second lower portion LP2 may be disposed directly on the second adhesive layer APL2 described later. The second lower portion LP2 may overlap the first lower portion LP1 when viewed in the first direction DR1. A first distance d1 in the first direction DR1 between the second lower portion LP2 and the first lower portion LP1 may range from about 15 mm to about 75 mm. As an example, the first distance d1 may be about 60 mm. The second lower portion LP2 may include at least one of polyethylene or polyvinylchloride. The second lower portion LP2 may include the same material as the first lower portion LP1. As an example, the second lower portion LP2 may include polyvinylchloride. The second lower portion LP2 may have a thickness t4 ranging from about 50 micrometers to about 400 micrometers. As an example, the thickness t4 of the second lower portion LP2 may be about 100 micrometers.

The second intermediate portion MP2 may be disposed on the second lower portion LP2. The second intermediate portion MP2 may be disposed directly on the second lower portion LP2. The second intermediate portion MP2 may include at least one of Teflon, polyethylene, polyvinylchloride, or polyether ether ketone. The second intermediate portion MP2 may be provided integrally with the second lower portion LP2. In the case where the second intermediate portion MP2 is provided integrally with the second lower portion LP2, the second lower portion LP2 and the second intermediate portion MP2 may include the same material. As an example, the second intermediate portion MP2 may include polyvinylchloride. The second intermediate portion MP2 may have hardness greater than a hardness of the second lower portion LP2. The second intermediate portion MP2 may overlap the first intermediate portion MP1 when viewed in the first direction DR1. A second distance d2 in the first direction DR1 between the second intermediate portion MP2 and the first intermediate portion MP1 may range from about 15 mm to about 75 mm. As an example, the second distance d2 may be about 60 mm.

The second upper portion HP2 may be disposed on the second intermediate portion MP2. The second upper portion HP2 may be disposed directly on the second intermediate portion MP2. The second lower portion LP2, the second intermediate portion MP2, and the second upper portion HP2 may be provided integrally with each other. The second upper portion HP2 may include at least one of Teflon, polyethylene, polyvinylchloride, or polyether ether ketone. As an example, each of the second lower portion LP2, the second intermediate portion MP2, and the second upper portion HP2 may include polyethylene.

The second upper portion HP2 may have hardness greater than a hardness of the second lower portion LP2. The hardness of the second upper portion HP2 may substantially the same as the hardness of the second intermediate portion MP2. The second upper portion HP2 may overlap the first upper portion HP1 when viewed in the first direction DR1. A width d3 in the first direction DR1 between the second upper portion HP2 and the first upper portion HP1 may be smaller than the width d2 in the first direction DR1 between the second intermediate portion MP2 and the first intermediate portion MP1. The width d3 in the first direction DR1 between the second upper portion HP2 and the first upper portion HP1 may be smaller than the width d1 in the first direction DR1 between the second lower portion LP2 and the first lower portion LP1. The third distance d3 in the first direction DR1 between the second upper portion HP2 and the first upper portion HP1 may range from about 5 mm to about 25 mm. As an example, the third distance d3 may be about 20 mm. According to the etching device ECD, since the third distance d3 is smaller than each of the first distance d1 and the second distance d2, a pressure applied by the etching solution ESL to a portion of the target substrate PWM, which overlaps a space between the first upper protrusion portion HPP1 and the second upper protrusion portion HPP2, may be greater than a pressure applied by the etching solution ESL to portions of the target substrate PWM, which respectively overlap the first upper protrusion portion HPP1 and the second upper protrusion portion HPP2, in a process of etching the target substrate PWM, and thus, the folding portion FP (refer to FIG. 16) may have a gentle curve shape when viewed in a cross-section.

A sum of a thickness t5 of the second intermediate portion MP2 and a thickness t6 of the second upper portion HP2 may range from about 500 micrometers to about 2000 micrometers. As an example, the sum of the thickness t5 of the second intermediate portion MP2 and the thickness t6 of the second upper portion HP2 may be about 1000 micrometers.

The second upper portion HP2 may include a second upper base portion HBP2 and a second upper protrusion portion HPP2. The second upper base portion HBP2 may be disposed directly on the second intermediate portion MP2. An end of the second upper base portion HBP2 may be aligned with an end of the second lower portion LP2. The end of the second upper base portion HBP2 may be aligned with an end of the second intermediate portion MP2. The second upper base portion HBP2 may have substantially the same area as an area of the second intermediate portion MP2 when viewed in the plane. The second upper protrusion portion HPP2 may extend from the second upper base portion HBP2 in a direction opposite to the first direction DR1. The second upper protrusion portion HPP2 may extend in a direction toward the first upper protrusion portion HPP1 from the second upper base portion HBP2. The width d3 in the first direction DR1 between the second upper portion HP2 and the first upper portion HP1 may be substantially the same as a width in the first direction DR1 between the second upper protrusion portion HPP2 and the first upper protrusion portion HPP1. The second upper protrusion portion HPP2 may have substantially the same thickness as the second upper base portion HBP2. A width L2 in the first direction DR1 of the second upper protrusion portion HPP2 may range from about 5 mm to about 25 mm. As an example, the width L2 in the first direction DR1 of the second upper protrusion portion HPP2 may be about 20 mm.

The third mask MK3 may be disposed on another surface of the target substrate PWM. The other surface of the target substrate PWM may be defined as a surface that faces the surface of the target substrate PWM on which the first mask MK1 and the second mask MK2 are disposed. The third mask MK3 may have substantially the same area as an area of the target substrate PWM when viewed in the plane. The third mask MK3 may be disposed directly on an upper surface of a third adhesive layer APL3 described later. The third mask MK3 may include at least one of polyethylene or polyvinylchloride. As an example, the third mask MK3 may include polyvinylchloride. The third mask MK3 may prevent the etching solution ESL from being in contact with the other surface of the target substrate PWM.

The adhesive layer APL may be disposed on the surface and the other surface of the target substrate PWM. The adhesive layer APL may include a polymer resin. As an example, the adhesive layer APL may include an acrylic resin. The adhesive layer APL may be cured and may lose its adhesive strength when exposed to an ultraviolet light. The adhesive layer APL may include the first adhesive layer APL1, the second adhesive layer APL2, and the third adhesive layer APL3.

The first adhesive layer APL1 may be disposed between the first mask MK1 and the target substrate PWM. The first adhesive layer APL1 may be disposed on a lower surface of the first mask MK1. The first adhesive layer APL1 may be disposed directly on the surface of the target substrate PWM. The first adhesive layer APL1 may fix the first mask MK1 to the one side of the target substrate PWM. The first adhesive layer APL1 may have a thickness P-t1 ranging from about 1 micrometer to about 100 micrometers. As an example, the thickness P-t1 of the first adhesive layer APL1 may be about 50 micrometers. The first adhesive layer APL1 may include a first adhesive base portion APB1 and a first cured portion APH1.

An end of the first adhesive base portion APB1 may be aligned with the end of the target substrate PWM. The first adhesive base portion APB1 may be provided integrally with the first cured portion APH1. The first cured portion APH1 may extend from the first adhesive base portion APB1 in the first direction DR1. A width H-t1 in the first direction DR1 of the first cured portion APH1 may range from about 1 mm to about 10 mm. As an example, the width H-t1 in the first direction DR1 of the first cured portion APH1 may be about 5 mm. The first adhesive base portion APB1 may be directly in contact with the target substrate PWM and may be attached to the target substrate PWM, and the first cured portion APH1 may be directly in contact with the target substrate PWM but may not be attached to the target substrate PWM. Since the first cured portion APH1 is not attached to the target substrate PWM, the etching solution ESL may be provided between the target substrate PWM and the first cured portion APH1 in a manufacturing method of a window using the etching device ECD according to the present disclosure. As a result, a boundary between a slant surface ICL (refer to FIG. 17) and a flat surface FL (refer to FIG. 17) may be gently formed, and thus, when the window WM (refer to FIG. 17) formed through the method of manufacturing the window according to the embodiment of the present disclosure is applied to the display device ED (refer to FIG. 2), a distortion occurring between the display area DP-DA (refer to FIG. 2) and the non-display area DP-NDA (refer to FIG. 2) of the display device ED (refer to FIG. 2) may be improved.

The second adhesive layer APL2 may be disposed between the second mask MK2 and the target substrate PWM. The second adhesive layer APL2 may be disposed directly on a lower surface of the second mask MK2. The second adhesive layer APL2 may be disposed directly on the surface of the target substrate PWM. The second adhesive layer APL2 may fix the second mask MK2 to the surface of the target substrate PWM. The second adhesive layer APL2 may be spaced apart from the first adhesive layer APL1 in the first direction DR1. A distance P-d in the first direction DR1 between the second adhesive layer APL2 and the first adhesive layer APL1 spaced apart from the second adhesive layer APL2 may range from about 15 mm to about 75 mm. As an example, the distance P-d in the first direction DR1 between the second adhesive layer APL2 and the first adhesive layer APL1 spaced apart from the second adhesive layer APL2 may be about 60 mm. The second adhesive layer APL2 may have a thickness P-t2 ranging from about 1 micrometer to about 100 micrometers. As an example, the thickness P-t2 of the second adhesive layer APL2 may be about 50 micrometers. The second adhesive layer APL2 may include a second adhesive base portion APB2 and a second cured portion APH2.

An end of the second adhesive base portion APB2 may be aligned with an end of the target substrate PWM. The second adhesive base portion APB2 may be provided integrally with the second cured portion APH2. The second cured portion APH2 may extend from the second adhesive base portion APB2 in the direction opposite to the first direction DR1. A width H-t2 in the first direction DR1 of the second cured portion APH2 may range from about 1 mm to about 10 mm. As an example, the width H-t2 in the first direction DR1 of the second cured portion APH2 may be about 5 mm. The second adhesive base portion APB2 may be directly in contact with the target substrate PWM and may be attached to the target substrate PWM, and the second cured portion APH2 may be directly in contact with the target substrate PWM but may not be attached to the target substrate PWM. Since the second cured portion APH2 is not attached to the target substrate PWM, the etching solution ESL may be provided between the target substrate PWM and the second cured portion APH2 in the method of manufacturing the window using the etching device ECD according to the present disclosure. As a result, the boundary between the slant surface ICL (refer to FIG. 17) and the flat surface FL (refer to FIG. 17) may be gently formed, and thus, when the window WM (refer to FIG. 17) formed through the method of manufacturing the window according to the embodiment of the present disclosure is applied to the display device ED (refer to FIG. 2), the distortion occurring between the display area DP-DA (refer to FIG. 2) and the non-display area DP-NDA (refer to FIG. 2) of the display device ED (refer to FIG. 2) may be improved.

The third adhesive layer APL3 may be disposed between the third mask MK3 and the target substrate PWM. The third adhesive layer APL3 may be disposed directly on an upper surface of the third mask MK3. The third adhesive layer APL3 may have substantially the same area as an area of the third mask MK3 when viewed in the plane. The third adhesive layer APL3 may have a thickness P-t3 ranging from about 1 micrometer to about 100 micrometers. As an example, the thickness P-t3 of the third adhesive layer APL3 may be about 50 micrometers. The third adhesive layer APL3 may fix the third mask MK3 to the other surface of the target substrate PWM.

Referring to FIG. 6B, the first lower portion LP1 may include two layers including different materials. The first lower portion LP1 may include a first layer LY1 and a second layer LY2 disposed on the first layer LY1. Each of the first layer LY1 and the second layer LY2 may include polyethylene or polyvinylchloride. As an example, the first layer LY1 may include polyvinylchloride, and the second layer LY2 may include polyethylene.

A second lower portion LP2 may include two layers including different materials. The second lower portion LP2 may include a first layer LY1′ and a second layer LY2′ disposed in the first layer LY1′. Each of the first layer LY1′ and the second layer LY2′ may include polyethylene or polyvinylchloride. As an example, the first layer LY1′ may include polyvinylchloride, and the second layer LY2′ may include polyethylene.

The first lower portion LP1 may include a different material from a first intermediate portion MP1. The first lower portion LP1 may include a different material from a first upper portion HP1. The first lower portion LP1 may include at least one of polyethylene or polyvinylchloride. Each of the first intermediate portion MP1 and the first upper portion HP1 may include at least one of Teflon, polyethylene, polyvinylchloride, or polyether ether ketone. As an example, the first lower portion LP1 may include polyethylene, and each of the first intermediate portion MP1 and the first upper portion HP1 may include polyether ether ketone.

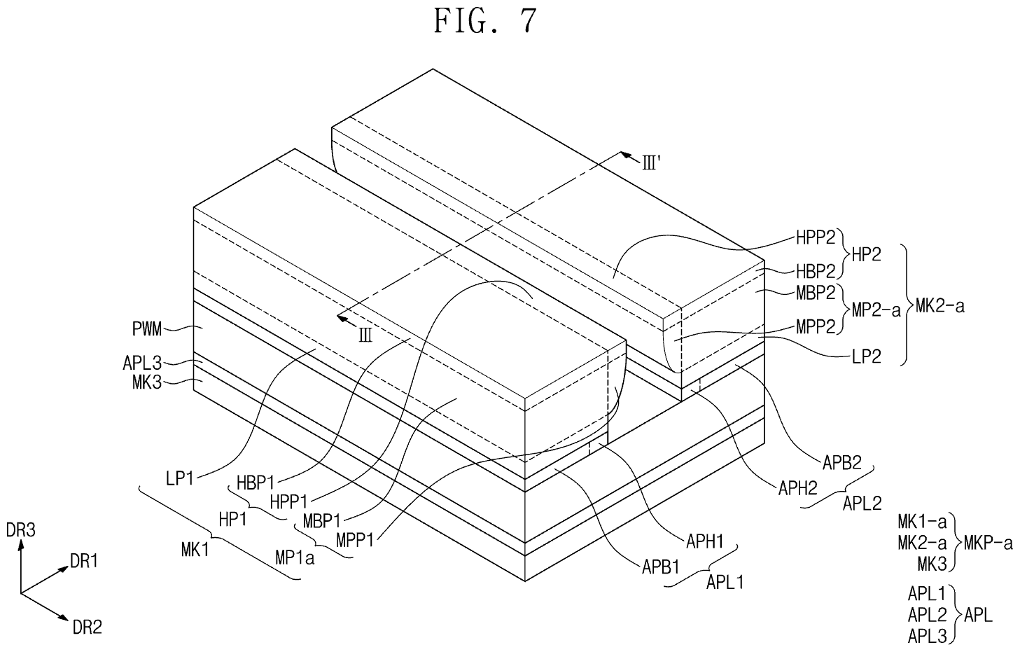

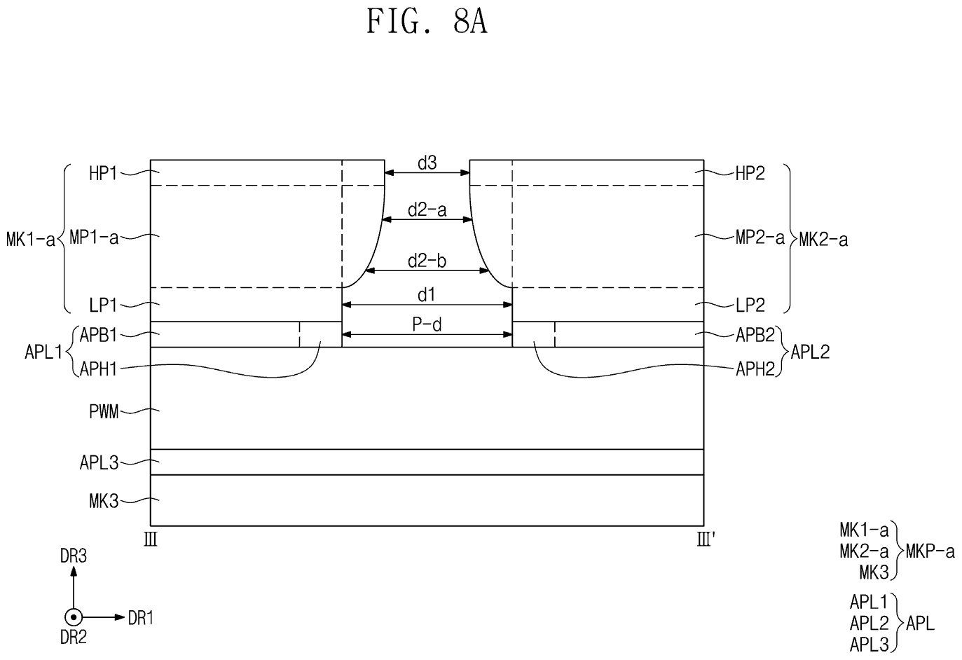

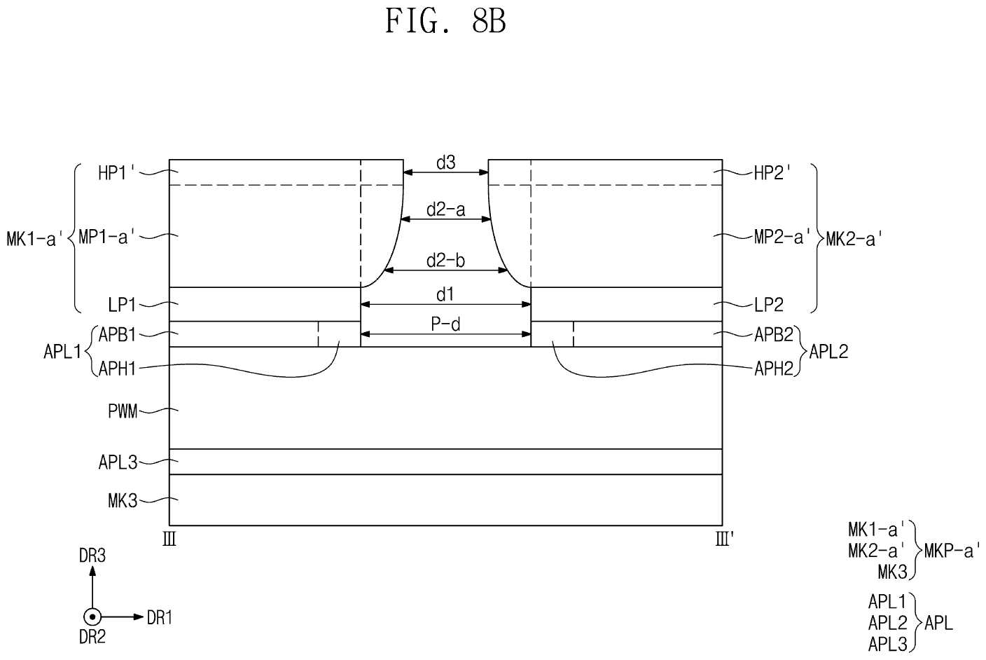

FIG. 7 is a perspective view illustrating an etching device according to an embodiment of the present disclosure. FIGS. 8A and 8B are cross-sectional views illustrating etching devices taken along a line III-III′ of FIG. 7. Each of a first intermediate portion included in a first mask and a second intermediate portion included in a second mask illustrated in FIG. 7 includes a side surface having a curved shape when viewed in the cross-section different from the first intermediate portion included in the first mask and the second intermediate portion included in the second mask illustrated in FIG. 5. In FIGS. 7, 8A, and 8B, detailed descriptions on the same elements as those described with reference to FIGS. 4 to 6B will be omitted.

Referring to FIGS. 7 and 8A, a mask part MKP-a may include the first mask MK1-a, the second mask MK2-a, and a third mask MK3. The first mask MK1-a may include a first lower portion LP1, the first intermediate portion MP1-a, and a first upper portion HP1. The first intermediate portion MP1-a may include a first intermediate base portion MBP1 and a first intermediate protrusion portion MPP1.

The first intermediate base portion MBP1 may be disposed directly on the first lower portion LP1. An end of the first intermediate base portion MBP1 may be aligned with an end of the first lower portion LP1. The end of the first intermediate base portion MBP1 may be aligned with an end of the first upper portion HP1. The first intermediate base portion MBP1 may have substantially the same area as an area of the first lower portion LP1 when viewed in the plane. The first intermediate protrusion portion MPP1 may extend from the first intermediate base portion MBP1 in the first direction DR1. The first intermediate protrusion portion MPP1 may include a side surface having a curved shape in which a slope of a tangent line increases along a thickness direction when viewed in cross-section. A width in the first direction DR1 of the first intermediate protrusion portion MPP1 may increase along the thickness direction. The width in the first direction DR1 of the first intermediate protrusion portion MPP1 may reach its maximum in a portion adjacent to the first upper portion HP1.

According to an embodiment, the first lower portion LP1, the first intermediate portion MP1-a, and the first upper portion HP1 may be provided integrally with each other. The first lower portion LP1 may include at least one of polyethylene or polyvinylchloride. Each of the first intermediate portion MP1-a and the first upper portion HP1 may include at least one of Teflon, polyethylene, polyvinylchloride, or polyether ether ketone. The first lower portion LP1, the first intermediate portion MP1-a, and the first upper portion HP1 may include the same material. As an example, each of the first lower portion LP1, the first intermediate portion MP1-a, and the first upper portion HP1 may include polyvinylchloride.

The second mask MK2-a may include a second lower portion LP2, the second intermediate portion MP2-a, and a second upper portion HP2. The second intermediate portion MP2-a may include a second intermediate base portion MBP2 and a second intermediate protrusion portion MPP2.

The second intermediate base portion MBP2 may be disposed directly on the second lower portion LP2. An end of the second intermediate base portion MBP2 may be aligned with an end of the second lower portion LP2. The end of the second intermediate base portion MBP2 may be aligned with an end of the second upper portion HP2. The second intermediate base portion MBP2 may have substantially the same area as an area of the second lower portion LP2 when viewed in the plane. The second intermediate protrusion portion MPP2 may extend from the second intermediate base portion MBP2 in the direction opposite to the first direction DR1. The second intermediate protrusion portion MPP2 may include a side surface having a curved shape in which a slope of a tangent line increases along the thickness direction when viewed in cross-section. A width in the first direction DR1 of the second intermediate protrusion portion MPP2 may increase along the thickness direction. The width in the first direction DR1 of the second intermediate protrusion portion MPP2 may reach its maximum in a portion adjacent to the second upper portion HP2.

A width d2-a and d2-b between the second intermediate protrusion portion MPP2 and the first intermediate protrusion portion MPP1, which are spaced apart from each other in the first direction DR1, may decrease along the thickness direction. In detail, the width d2-b in a portion adjacent to a target substrate PWM may be smaller than the width d2-a in a portion adjacent to each of the first upper portion HP1 and the second upper portion HP2.

According to an embodiment, each of the first intermediate portion MP1-a and the second intermediate portion MP2-a may include the side surface having the curved shape when viewed in the cross-section, and thus, the difficulty in manufacturing the mask part MKP-a may be alleviated.

Different from the first mask MK1-a and the second mask MK2-a illustrated in FIG. 8A, in a first mask MK1-a′ and a second mask MK2-a′ illustrated in FIG. 8B, a first lower portion LP1 may not be provided integrally with a first intermediate portion MP1-a', and a second lower portion LP2 may not be provided integrally with a second intermediate portion MP2-a′.

Referring to FIG. 8B, the first mask MK1-a′ may include the first lower portion LP1, the first intermediate portion MP1-a′ disposed on the first lower portion LP1, and a first upper portion HP1′ disposed on the first intermediate portion MP1-a′ and provided integrally with the first intermediate portion MP1-a′. The first lower portion LP1 may include a different material from the first intermediate portion MP1-a′. The first lower portion LP1 may include a different material from the first upper portion HP1′. The first lower portion LP1 may include at least one of polyethylene or polyvinylchloride. Each of the first intermediate portion MP1-a′ and the first upper portion HP1′ may include at least one of Teflon, polyethylene, polyvinylchloride, or polyether ether ketone. As an example, the first lower portion LP1 may include polyethylene, and each of the first intermediate portion MP1-a′ and the first upper portion HP1′ may include Teflon. Each of the first intermediate portion MP1-a′ and the first upper portion HP1′ may have hardness greater than a hardness of the first lower portion LP1.

The second mask MK2-a′ may include the second lower portion LP2, the second intermediate portion MP2-a′ disposed on the second lower portion LP2, and a second upper portion HP2′ disposed on the second intermediate portion MP2-a′ and provided integrally with the second intermediate portion MP2-a′. The second lower portion LP2 may include a different material from the second intermediate portion MP2-a′. The second lower portion LP2 may include a different material from the second upper portion HP2′. The second lower portion LP2 may include at least one of polyethylene or polyvinylchloride. Each of the second intermediate portion MP2-a′ and the second upper portion HP2′ may include at least one of Teflon, polyethylene, polyvinylchloride, or polyether ether ketone. As an example, the second lower portion LP2 may include polyethylene, and each of the second intermediate portion MP2-a′ and the second upper portion HP2′ may include Teflon. Each of the second intermediate portion MP2-a′ and the second upper portion HP2′ may have hardness greater than a hardness of the second lower portion LP2.

Hereinafter, the method of manufacturing the window using the etching device according to the embodiment of the present disclosure will be described.

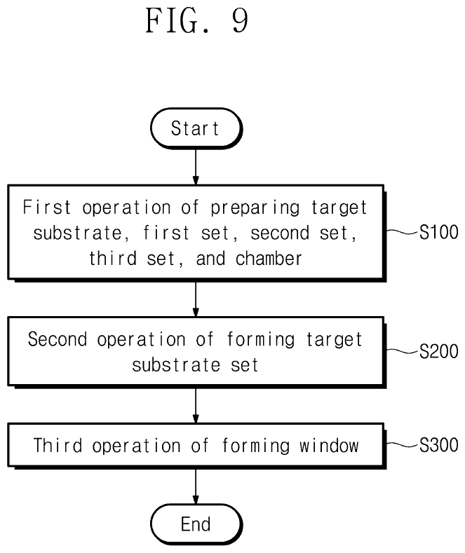

FIG. 9 is a flowchart illustrating the method of manufacturing the window according to an embodiment of the present disclosure. FIGS. 10 to 15 are views illustrating the method of manufacturing the window according to an embodiment of the present disclosure.

In the descriptions of the method and processes herein, the operations may be performed in a different order than the order shown and/or described, or the operations may be performed in different orders or at different times. Certain operations may also be left out of the flowcharts, one or more operations may be repeated, or other operations may be added. Descriptions that an element “may be prepared,” “may be formed,” “may be disposed,” and the like include methods, processes, and techniques for preparing, forming, and disposing the element, and the like in accordance with example aspects described herein.

Referring to FIG. 9, the method of manufacturing the window includes a first operation (S100) preparing the target substrate, a first set, a second set, a third set, and the chamber, a second operation (S200) forming a target substrate set, and a third operation (S300) forming the window.

Referring to FIG. 10, in the first operation, the first set ST1 includes a preliminary first adhesive layer PAPL1 and the first mask MK1 disposed on the preliminary first adhesive layer PAPL1. The second set ST2 includes a preliminary second adhesive layer PAPL2 and the second mask MK2 disposed on the preliminary second adhesive layer PAPL2. The third set ST3 includes the third adhesive layer APL3 and the third mask MK3 disposed on a lower surface of the third adhesive layer APL3. The chamber CB contains the etching solution ESL.

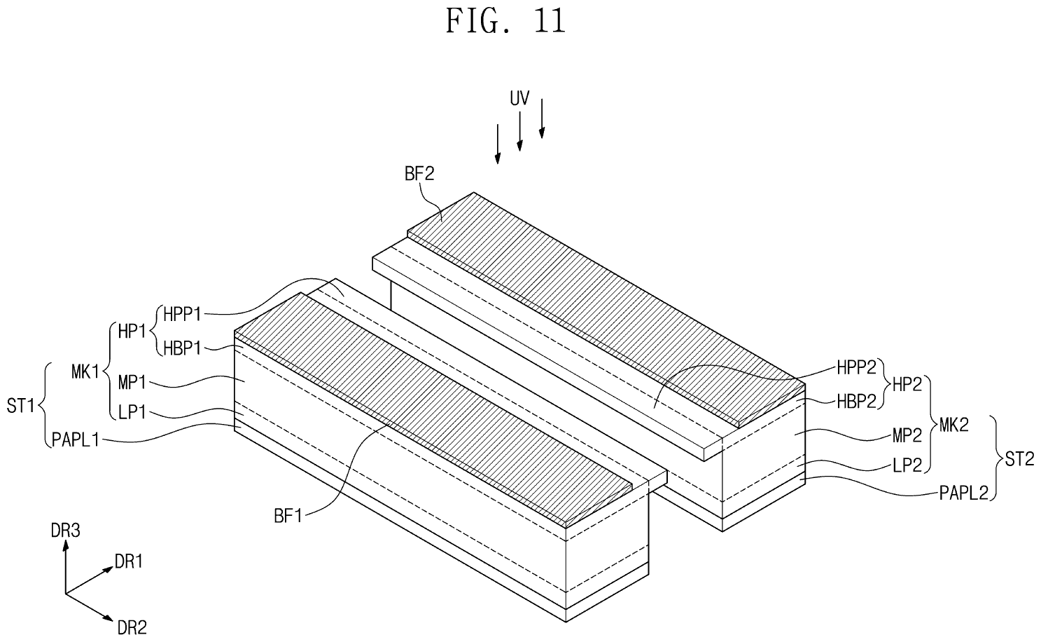

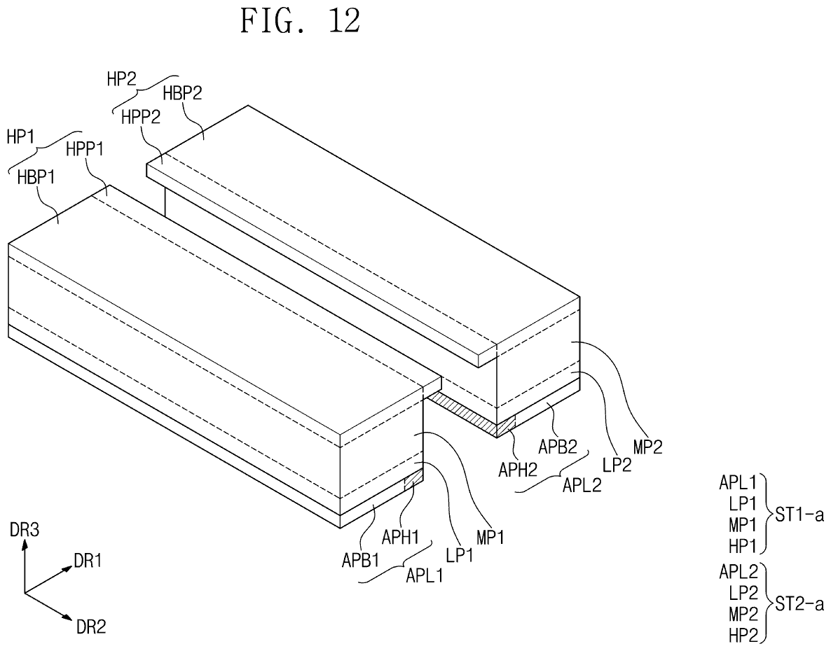

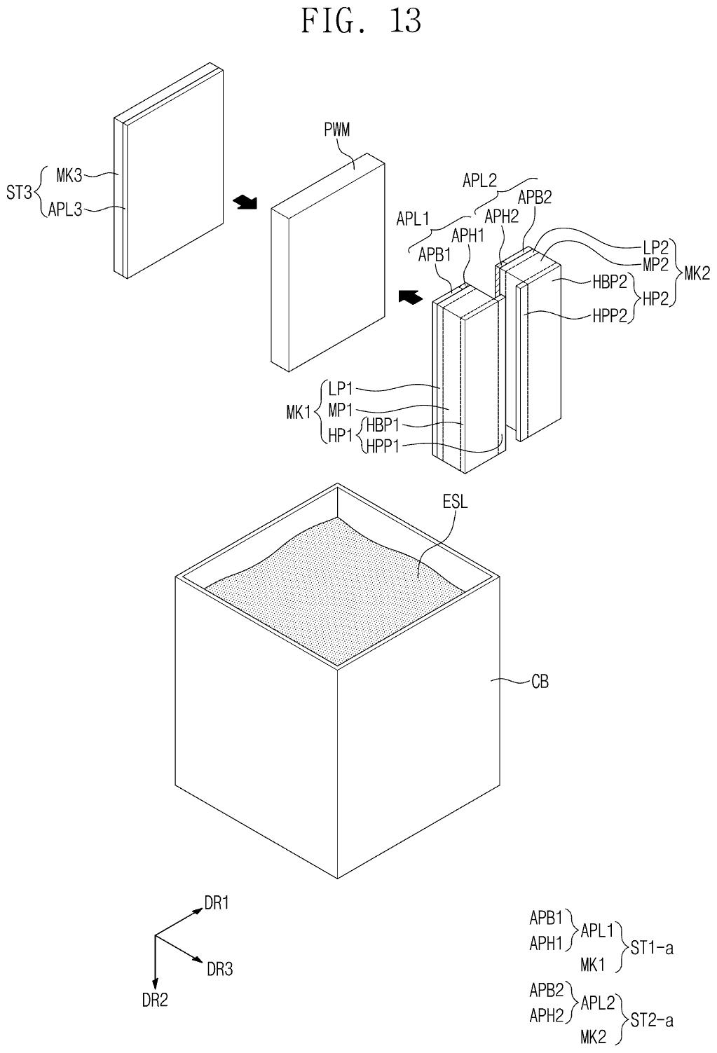

Referring to FIGS. 11 and 12, the method of manufacturing the window may further include curing a portion of the first adhesive layer APL1 and a portion of the second adhesive layer APL2 between the first operation and the second operation. The curing of the portion of the first adhesive layer APL1 and the portion of the second adhesive layer APL2 may be performed between the second operation and the third operation. That is, each of the portion of the first adhesive layer APL1 and the portion of the second adhesive layer APL2 may be cured by an ultraviolet light UV after each of the first set ST1 and the second set ST2 is disposed on the target substrate PWM (refer to FIG. 13). In the curing of the portion of the first adhesive layer APL1 and the portion of the second adhesive layer APL2, the method may include disposing a first film BF1 on the first set ST1, and disposing a second film BF2 on the second set ST2. Each of the first film BF1 and the second film BF2 may include a material that absorbs or reflects the ultraviolet light.

The first film BF1 may overlap a portion of the preliminary first adhesive layer PAPL1 when viewed in the plane. The second film BF2 may overlap a portion of the preliminary second adhesive layer PAPL2 when viewed in the plane. The method may include emitting ultraviolet light UV toward and irradiating each of the first set ST1 and the second set ST2 in the direction opposite to the third direction DR3, and thus, the first adhesive layer APL1 and the second adhesive layer APL2 may be formed. The ultraviolet light UV may have a wavelength ranging from about 10 nm to about 400 nm. For example, the ultraviolet light UV may have a wavelength of about 150 nm.

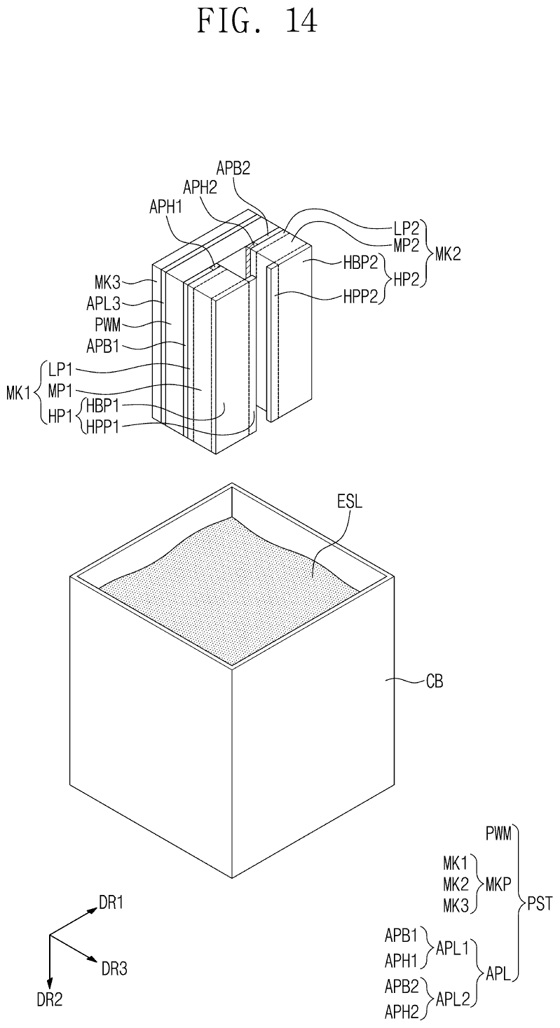

Referring to FIGS. 13 and 14, in the second operation of forming the target substrate set PST, the method may include attaching the first set ST1 to the surface of the target substrate PWM using the first adhesive layer APL1, attaching the second set ST2 to the surface using the second adhesive layer APL2 such that the second set ST2 is spaced apart from the first set ST1 in the first direction DR1, and attaching the third set ST3 to the other surface of the target substrate PWM using the third adhesive layer APL3. The first set ST1 may be attached to the target substrate PWM by the first adhesive base portion APB1 included in the first adhesive layer APL1. The second set ST2 may be attached to the target substrate PWM by the second adhesive base portion APB2 included in the second adhesive layer APL2. The target substrate set PST may be located in a direction opposite to the second direction DR2 in an opened portion of the chamber CB.

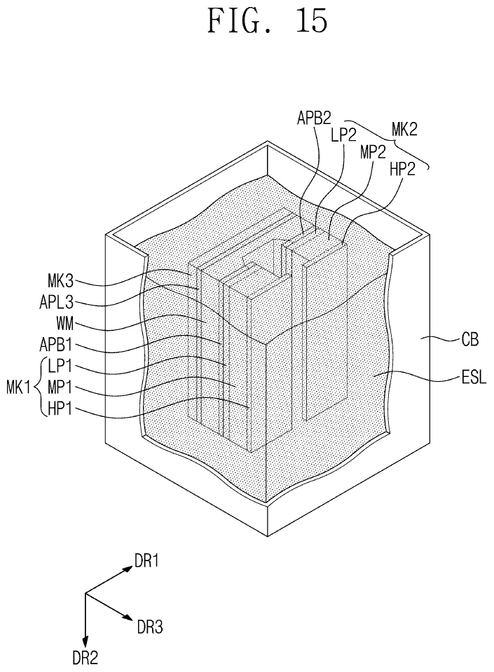

Referring to FIGS. 14 and 15, in the third operation of forming the window, the method may include moving or transporting the target substrate set PST in the second direction DR2 and immersing the target substrate set PST into the etching solution ESL contained in the chamber CB. Based on the immersion, a portion of the etching solution ESL may be provided or flow between the first cured portion APH1 and the target substrate PWM and between the second cured portion APH2 and the target substrate PWM. A relatively smaller amount of the etching solution ESL may be provided to or contact portions of the upper surface of the target substrate PWM, which respectively overlap the first cured portion APH1 and the second cured portion APH2, compared to a portion of the upper surface of the target substrate PWM, which does not overlap the first adhesive layer APL1 and the second adhesive layer APL2. Accordingly, a boundary between the folding portion FP (refer to FIG. 16) and the non-folding portions NFP1 and NFP2 (refer to FIG. 16) may have a gentle curve shape, and thus, a visibility of the display device may be improved.

The etching solution ESL may include a fluorine-containing compound. The etching solution ESL may contain at least one of hydrofluoric acid or ammonium difluoride. A weight ratio of ammonium difluoride based on a total weight of the etching solution ESL may range from about 5 wt % to about 15 wt %. As an example, the weight ratio of ammonium difluoride based on the total weight of the etching solution ESL may be about 10 wt %.

The third operation may include moving (i.e., according to a reciprocating motion) the target substrate set PST in an arbitrary direction and a direction opposite the arbitrary direction at a speed ranging from about 100 mm/min to about 500 mm/min while the target substrate set PST is immersed in the etching solution ESL. As an example, the method may include moving the target substrate set PST (i.e., according to a reciprocating motion) in the third direction DR3 and the direction opposite to the third direction DR3 at a speed of about 100 mm/min. In an example in which the target substrate set PST is moved in the arbitrary direction and the opposite direction while the target substrate set PST is immersed in the etching solution ESL, a portion of the target substrate PWM dissolved by the etching solution ESL may be separated from the target substrate PWM, and thus, the accuracy of the process may be improved.

FIG. 16 is a perspective view illustrating a window according to an embodiment of the present disclosure. FIG. 17 is a cross-sectional view illustrating the window taken along a line IV-IV′ of FIG. 16. FIG. 16 illustrates the window illustrated in FIG. 15 after separating the window from the first, second, and third sets.

Referring to FIGS. 16 and 17, the window WM may include the first non-folding portion NFP1, the folding portion FP, and the second non-folding portion NFP2. A groove HM′ may be defined through the window WM. The groove HM′ may be defined by the flat surface FL and the slant surface ICL. Since a thickness of the folding portion FP is smaller than a thickness of the first non-folding portion NFP1 and a thickness of the second non-folding portion NFP2, the groove HM′ may enable the window WM to have characteristics favorable for folding.

A width FLL in the first direction DR1 of the flat surface FL may be greater than or equal to about 5 mm and smaller than or equal to about 15 mm. As an example, the width FLL in the first direction DR1 of the flat surface FL may be about 9 mm. A width SL in the first direction DR1 of the slant surface ICL may be greater than or equal to about 3 mm and smaller than or equal to about 10 mm. A sum FAL of the width FLL in the first direction DR1 of the flat surface FL and the width SL in the first direction DR1 of the slant surface ICL may range from about 15 mm to about 30 mm. An etching depth EDL may be defined by a step difference between the flat surface FL and the non-folding portions NFP1 and NFP2. The etching depth EDL may range from about 40 micrometers to about 175 micrometers.

According to the method of manufacturing the window using the etching device of the present disclosure, since the third distance d3 (refer to FIGS. 6A and 6B) is smaller than each of the first distance d1 (refer to FIGS. 6A and 6B) and the second distance d2 (refer to FIGS. 6A and 6B), in the process of etching the target substrate PWM, the pressure applied by the etching solution ESL to the portion of the target substrate PWM, which overlaps the space between the first upper portion HP1 and the second upper portion HP2, may be greater than the pressure applied by the etching solution ESL to the portion of the target substrate PWM, which overlaps each of the first upper protrusion portion HPP1 (refer to FIGS. 6A and 6B) and the second upper protrusion portion HPP2 (refer to FIGS. 6A and 6B). As a result, the folding portion FP (refer to FIG. 16) may have the gentle curve shape when viewed in cross-section, the difficulty in manufacturing the window may be improved, and the visibility of the display device may be enhanced.

Although the embodiments of the present disclosure have been described, it is understood that the present disclosure should not be limited to the example embodiments but various changes and modifications can be made by one ordinary skilled in the art within the spirit and scope of the present disclosure as hereinafter claimed. Therefore, the disclosed subject matter should not be limited to any single embodiment described herein, and the scope of the embodiments of the present disclosure shall be determined according to the attached claims.

What is claimed is:

1. An etching device comprising:
a mask part comprising:
a first mask disposed on a surface of a target substrate,
a second mask disposed on the surface and spaced apart from the first mask in a first direction, and
a third mask disposed on another surface of the target substrate, wherein the other surface of the target substrate faces the surface; and
an adhesive layer comprising:
a first adhesive layer disposed between the first mask and the target substrate,
a second adhesive layer spaced apart from the first adhesive layer in the first direction and disposed between the second mask and the target substrate, and
a third adhesive layer disposed between the third mask and the target substrate,
wherein:
the first mask comprises:
a first lower portion disposed on the first adhesive layer,
a first intermediate portion disposed on the first lower portion, and
a first upper portion disposed on the first intermediate portion,
the second mask comprises:
a second lower portion disposed on the second adhesive layer,
a second intermediate portion disposed on the second lower portion, and
a second upper portion disposed on the second intermediate portion,
the first upper portion comprises:
a first upper base portion aligned with an end of the first lower portion, and
a first upper protrusion portion extending from the first upper base portion in the first direction, and
the second upper portion comprises:
a second upper base portion aligned with an end of the second lower portion, and
a second upper protrusion portion extending from the second upper base portion in a direction opposite to the first direction.

2. The etching device of claim 1, wherein a first distance in the first direction between the first lower portion and the second lower portion is substantially equal to a second distance in the first direction between the first intermediate portion and the second intermediate portion.

3. The etching device of claim 1, wherein a first distance in the first direction between the first lower portion and the second lower portion is greater than a third distance in the first direction between the first upper portion and the second upper portion.

4. The etching device of claim 1, wherein a second distance in the first direction between the first intermediate portion and the second intermediate portion is greater than a third distance in the first direction between the first upper portion and the second upper portion.

5. The etching device of claim 1, wherein a width in the first direction between the first adhesive layer and the second adhesive layer is greater than a third distance in the first direction between the first upper portion and the second upper portion.

6. The etching device of claim 1, wherein:
the first adhesive layer comprises a first adhesive base portion and a first cured portion extending from the first adhesive base portion to the first direction, the second adhesive layer comprises a second adhesive base portion and a second cured portion extending from the second adhesive base portion to the direction opposite to the first direction, the first cured portion is not attached to the target substrate, and
the second cured portion is not attached to the target substrate.

7. The etching device of claim 6, wherein each of a width in the first direction of the first cured portion and a width in the first direction of the second cured portion ranges from about 1 mm to about 10 mm.

8. The etching device of claim 1, wherein:
the first mask is disposed directly on an upper surface of the first adhesive layer,
the second mask is disposed directly on an upper surface of the second adhesive layer, and
the third mask is disposed directly on a lower surface of the third adhesive layer.

9. The etching device of claim 1, wherein each of a thickness of the first lower portion and a thickness of the second lower portion ranges from about 50 micrometers to about 400 micrometers.

10. The etching device of claim 1, wherein each of a sum of a thickness of the first intermediate portion and a thickness of the first upper portion and a sum of a thickness of the second intermediate portion and a thickness of the second upper portion ranges from about 500 micrometers to about 2000 micrometers.

11. The etching device of claim 1, wherein the adhesive layer has a thickness ranging from about 1 micrometer to about 100 micrometers.

12. The etching device of claim 1, wherein a third distance in the first direction between the first upper portion and the second upper portion ranges from about 5 mm to about 25 mm.

13. The etching device of claim 1, wherein a second distance in the first direction between the first intermediate portion and the second intermediate portion ranges from about 15 mm to about 75 mm.

14. The etching device of claim 1, wherein a second distance in the first direction between the first intermediate portion and the second intermediate portion decreases along a thickness direction of the etching device.

15. The etching device of claim 1, wherein each of the first mask, the second mask, and the third mask comprises at least one of Teflon, polyethylene, polyvinylchloride, or polyether ether ketone.

16. The etching device of claim 1, wherein each of the first upper portion and the second upper portion comprises at least one of Teflon, polyvinylchloride, or polyether ether ketone.

17. A method of manufacturing a window, comprising:
a first operation of preparing:
a target substrate,
a first set comprising a preliminary first adhesive layer and a first mask disposed on the preliminary first adhesive layer,
a second set comprising a second adhesive layer and a second mask disposed on the second adhesive layer,
a third set comprising a third adhesive layer and a third mask disposed on a lower surface of the third adhesive layer, and
a chamber accommodating an etching solution;
a second operation of forming a target substrate set, comprising:
attaching the first set to a surface of the target substrate using the first adhesive layer,
attaching the second set to the surface of the target substrate using the second adhesive layer such that the second set is spaced apart from the first set in a first direction, and
attaching the third set to another surface of the target substrate using the third adhesive layer, wherein the other surface of the target substrate faces the surface; and
a third operation of forming the window, comprising:
moving the target substrate set in a second direction intersecting the first direction; and
immersing the target substrate set into the etching solution in the chamber,
wherein:
the first mask comprises:
a first lower portion disposed on the first adhesive layer,
a first intermediate portion disposed on the first lower portion, and
a first upper portion disposed on the first intermediate portion,
the second mask comprises:
a second lower portion disposed on the second adhesive layer,
a second intermediate portion disposed on the second lower portion, and
a second upper portion disposed on the second intermediate portion,
the first upper portion comprises:
a first upper base portion aligned with an end of the first lower portion, and
a first upper protrusion portion extending from the first upper base portion in the first direction, and
the second upper portion comprises:
a second upper base portion aligned with an end of the second lower portion, and
a second upper protrusion portion extending from the second upper base portion in a direction opposite to the first direction.

18. The method of claim 17, further comprising irradiating each of the first set and the second set with an ultraviolet light, between the first operation and the second operation, wherein irradiating each of the first set and the second set with the ultraviolet light cures a portion of the first adhesive layer and a portion of the second adhesive layer.

19. The method of claim 18, wherein:
based on the second operation, the first adhesive layer comprises:
a first adhesive base portion, and
a first cured portion extending from the first adhesive base portion in the first direction,
based on the second operation, the second adhesive layer comprises:
a second adhesive base portion, and
a second cured portion extending from the second adhesive base portion in the direction opposite to the first direction, and
in the third operation, a portion of the etching solution is provided between the first cured portion and the target substrate and between the second cured portion and the target substrate.

20. The method of claim 17, wherein the third operation comprises moving the target substrate set in an arbitrary direction and a direction opposite the arbitrary direction at a speed ranging from about 100 mm/min to about 500 mm/min while the target substrate set is immersed in the etching solution.
